(19) United States
(12) Patent Application Publication
(10) Pub. No.: US 2023/0401664 A1
(43) Pub. Date: Dec. 14, 2023

(54) MOBILITY SERVICE PLATFORM AND MOVILITY SERVICE METHOD PROVIDING TRANSFER SERVICE

(71) Applicants: Hyundai Motor Company, Seoul (KR); Kia Corporation, Seoul (KR)

(72) Inventors: Yoonsun Kye, Seoul (KR); Kyong Enn Min, Seoul (KR); Hyungu Roh, Seongnam-si (KR); Jae Oh Zeon, Seongnam-si (KR); Hyunjin Lee, Seoul (KR); Jae Hyun Yoo, Seongnam-si (KR); Younghyun Ju, Yongin-si (KR); Eonjoung Choi, Seoul (KR)

(21) Appl. No.: 17/976,149

(22) Filed: Oct. 28, 2022

(30) Foreign Application Priority Data
Jun. 10, 2022 (KR) 10-2022-0071041

(51) Int. Cl. G06Q 50/30; G06Q 50/26; G01C 21/34

(52) U.S. Cl. CPC G06Q 50/30; G06Q 50/26; G01C 21/3438

(57) ABSTRACT

Disclosed is a mobility service platform including: a public transportation inquiry server for collecting traveling information for a public transportation; and a mobility service server for providing a mobility service for transporting a user via a rideshare vehicle traveling on a route based on a request from the user, and for providing a transfer service between the rideshare vehicle and the public transportation. The mobility service server may receive a starting location and a destination from a user terminal for providing the mobility service, receive the traveling information from the public transportation inquiry server, generate, based on the starting location, the destination, and the traveling information, at least one recommended route among a plurality of routes that are traveled by a combination of the rideshare vehicle and the public transportation, and reserve the mobility service based on the at least one recommended route.

### CROSS-REFERENCE TO RELATED APPLICATION

This application claims priority to and the benefit of Korean Patent Application No. 10-2022-0071041 filed in the Korean Intellectual Property Office on Jun. 10, 2022, the entire contents of which are incorporated herein by reference.

### BACKGROUND

### (a) Field

The present disclosure relates to a mobility service platform and a mobility service method of providing a transfer service.

### (b) Description of the Related Art

Users who use the ridesharing service often use public transportation services together due to the limitation of the area covered by the ridesharing service. In the currently provided route finding service, only route guidance through which a user can move by using a public transportation service or vehicle is provided without considering a ridesharing service.

As such, it may be difficult for the user using the ridesharing service to know the route from a starting location to a destination by using the public transportation service together. In addition, it is difficult for the user to determine which route among various routes between the starting location and the destination is an optimal route appropriate for the user's needs.

The above information disclosed in this Background section is only for enhancement of understanding of the background of the disclosure, and therefore it may contain information that does not form the prior art that is already known to a person of ordinary skill in the art.

### SUMMARY

The present disclosure has been made in an effort to provide a mobility service platform and a mobility service method, which are capable of informing users of an optimal transfer route and method between a vehicle providing a ridesharing service and a transportation providing a public transportation service.

A mobility service platform may include: a public transportation inquiry server for collecting traveling information for a public transportation; and a mobility service server for providing a mobility service for transporting a user via a rideshare vehicle traveling on a route based on a request from the user, and for providing a transfer service between the rideshare vehicle and the public transportation. The mobility service server may be configured to: receive a starting location and a destination from a user terminal for providing the mobility service; receive the traveling information from the public transportation inquiry server; generate, based on the starting location, the destination, and the traveling information, at least one recommended route among a plurality of routes that are traveled by a combination of the rideshare vehicle and the public transportation; and reserve the mobility service based on the at least one recommended route.

The transfer service may enable the user to move from the starting location to a transfer point via the public transportation, and move from the transfer point to the destination via the rideshare vehicle.

The mobility service server may be further configured to, based on a scheduled transfer time required to move from a predetermined location to the transfer point via the public transportation exceeding a first reference value, make a reservation for the mobility service for moving from the transfer point to the destination via the rideshare vehicle.

The mobility service server may be further configured to cancel the reservation based on not receiving, within a predetermined time duration after making the reservation, a reservation decision message indicating reservation approval from the user terminal.

The mobility service server may be further configured to cancel the reservation based on a scheduled transfer time not satisfying a second reference value within a predetermined time duration after making the reservation.

The mobility service server may be further configured to receive, from the public transportation inquiry server and based on receiving from the user terminal a user selection input for the at least one recommended route, traveling information about a first public transportation on the selected route.

The mobility service server may be further configured to receive, from the user terminal and based on a user selection input for the at least one recommended route not being received from the user terminal, information indicating: a location of the user, and a first public transportation; receive, from the public transportation inquiry server, traveling information for a plurality of public transportations; and determine, based on the traveling information and the location of the user, traveling information of the public transportation that the user rode among the plurality of public transportations.

The mobility service server may be further configured to, based on a scheduled transfer time required to move from a predetermined location to the transfer point via the public transportation satisfying a reference value, transmit, to the user terminal, a push notification message indicating that a reservation for the mobility service from the transfer point to the destination is available.

The mobility service server may be further configured to, based on receiving a message indicating a reservation approval for the push notification, make the reservation.

The transfer service may enable the user to move from the starting location to a transfer point via the rideshare vehicle, and move from the transfer point to the destination via the public transportation.

The mobility service server may be further configured to: receive, from the user terminal, information about: a selected route from among the at least one recommended route, and a scheduled transfer time, wherein the scheduled transfer time indicates when the user is expected to ride the public transportation at the transfer point on the selected route.

The mobility service server may be further configured to estimate, based on the scheduled transfer time and a time required to move from the starting location to the transfer point via the rideshare vehicle, a time at which the user is expected to ride the rideshare vehicle.

The mobility service server may be further configured to determine, among a plurality of routes that are traveled by the combination of the rideshare vehicle and the public transportation from the starting location to the destination, a recommended route that satisfies a predetermined condition, wherein the predetermined condition includes at least one of: maximizing a distance traveled by the rideshare vehicle, or minimizing a time required to travel from the starting location to the destination.

A method may include: receiving, by a mobility service server and from a user terminal: information on a starting location and a destination, and a request for a transfer service in which a user moves from the starting location to a transfer point via a public transportation, and moves from the transfer point to the destination via a rideshare vehicle; determining, by the mobility service server, at least one recommended route that is traveled by a combination of the rideshare vehicle and the public transportation based on the starting location, the destination, and traveling information for the public transportation; transmitting the determined at least one recommended route to the user terminal; based on a selection input for one of the at least one recommended route being received from the user terminal, receiving, by the mobility service server and from a public transportation inquiry server, traveling information for a plurality of public transportations on the selected route; and estimating, by the mobility service server, a scheduled transfer time required to move from a predetermined location to the transfer point via the public transportation.

The method may further comprise reserving, by the mobility service server, a mobility service for moving from the transfer point to the destination via the rideshare vehicle based on the scheduled transfer time satisfying a first reference value.

The method may further include transmitting, by the mobility service server, to the user terminal, and based on the scheduled transfer time satisfying a first reference value, a push notification message indicating that a reservation for a mobility service for moving from the transfer point to the destination via the rideshare vehicle is available.

The method may further include: based on a second selection input for one of the at least one recommended route being not received from the user terminal, receiving, by the mobility service server and from the user terminal, information indicating: a location of the user, and a second public transportation; receiving, by the mobility service server and from the public transportation inquiry server, traveling information for a plurality of second public transportations; determining, by the mobility service server, based on the traveling information for the plurality of second public transportations, and further based on an area in which a mobility service is available, at least one candidate transfer point for transferring to the rideshare vehicle; and estimating, by the mobility service server, at least one time required to move from a predetermined location to each of the at least one candidate transfer point via the second public transportation.

The method may further include: reserving, by the mobility service server, a mobility service for moving to the destination via the rideshare vehicle from a candidate transfer location, of the at least one candidate transfer location, corresponding to the estimated at least one time satisfying a reference value.

The method may further include transmitting, by the mobility service server, a push notification message indicating that a reservation is available for the mobility service for moving via the rideshare vehicle from a location, at which the estimated at least one time satisfies a reference value among the determined at least one candidate transfer point, to the destination.

Determining of the at least one recommended route may include: generating, based on the starting location, the destination, and the traveling information for the public transportation, a plurality of routes that are traveled by the combination of the rideshare vehicle and the public transportation; and determining, among the plurality of routes, the at least one recommended route that satisfies a predetermined condition including at least one of: a distance traveled by the rideshare vehicle, or a time required to move from the starting location to the destination.

A method may include: receiving, by a mobility service server and from a user terminal: information on a starting location and a destination, and a request for a transfer service in which a user moves from the starting location to a transfer point via a rideshare vehicle, and moves from the transfer point to the destination via a public transportation; determining, by the mobility service server, at least one recommended route that is traveled by a combination of the rideshare vehicle and the public transportation based on the starting location, the destination, and traveling information for the public transportation; transmitting the determined at least one recommended route to the user terminal; based on a selection input for one of the at least one recommended route being received from the user terminal, receiving, by the mobility service server and from the user terminal, an input of a scheduled transfer time at which the user is expected to ride the public transportation at the transfer point on a selected route among the at least one recommended route; estimating, by the mobility service server, based on the scheduled transfer time, and further based on a time required to move from the starting location to the transfer point via the rideshare vehicle, a first time at which the user is expected to ride the rideshare vehicle; and based on the first time satisfying a reference value, performing one of: reserving, by the mobility service server, a mobility service for moving from the starting location to the transfer point via the rideshare vehicle, or transmitting, to the user terminal, a push notification message indicating that a reservation for the mobility service is available.

The method may further include: based on the selection input for the one of the at least one recommended route being received from the user terminal and further based on a second selection input not being received from the user terminal for the scheduled transfer time at which the user is expected to ride the public transportation at the transfer point among the at least one recommended route, estimating, by the mobility service server and based on a current location of the user and the selected route, a second time at which the user is expected to ride the rideshare vehicle; and based on a time period relative to the second time satisfying a second reference value, performing one of: reserving, by the mobility service server, the mobility service for moving from the starting location to the transfer point via the rideshare vehicle, or transmitting the push notification message indicating that the reservation for the mobility service is available.

The method may further include: receiving, by the mobility service server and from the user terminal, a current location of the user; receiving, by the mobility service server and from a public transportation inquiry server, information on the public transportation on the selected route; and transmitting, by the mobility service server, to the user terminal, and based on the information on the public transportation, a push notification message for the public transportation.

The information on the public transportation may include traveling information for a plurality of transportations.

The method may further include, based on a second selection input for the one of the at least one recommended route being not received from the user terminal, transmitting, by the mobility service server and to the user terminal, the push notification message indicating that the reservation for the mobility service for moving from the starting location to the destination via the rideshare vehicle is available.

### BRIEF DESCRIPTION OF THE DRAWINGS

FIG. 1 is a block diagram schematically illustrating an example mobility service platform providing a transfer service using a mobility service and a public transportation service.

FIG. 2 is a flowchart illustrating an example mobility service method.

FIG. 3 is a flowchart illustrating an example mobility service method.

FIG. 4 is a flowchart illustrating an example mobility service method.

FIG. 5 is a flowchart illustrating an example mobility service method.

### DETAILED DESCRIPTION

Hereinafter, one or more example embodiments disclosed in the present specification will be described in detail with reference to the accompanying drawings, and the same or similar constituent element is denoted by the same reference numeral regardless of a reference numeral, and a repeated description thereof will be omitted. Suffixes, “module” and and/or “unit” for a constituent element used for the description below are given or mixed in consideration of only easiness of the writing of the specification, and the suffix itself does not have a discriminated meaning or role. Further, in describing the exemplary embodiment disclosed in the present disclosure, when it is determined that detailed description relating to well-known functions or configurations may make the subject matter of the exemplary embodiment disclosed in the present disclosure unnecessarily ambiguous, the detailed description will be omitted. Further, the accompanying drawings are provided for helping to easily understand exemplary embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as “first” and “second,” are used for describing various constituent elements, but the constituent elements are not limited by the terms. The terms are used only to discriminate one constituent element from another constituent element.

It should be understood that when one constituent element is referred to as being “coupled to” or “connected to” another constituent element, one constituent element can be directly coupled to or connected to the other constituent element, but intervening elements may also be present. By contrast, when one constituent element is referred to as being “directly coupled to” or “directly connected to” another constituent element, it should be understood that there are no intervening elements.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

In addition, the terms “-er”, “-or”, and “module” described in the specification mean units for processing at least one function and operation, and can be implemented by hardware components or software components, and combinations thereof.

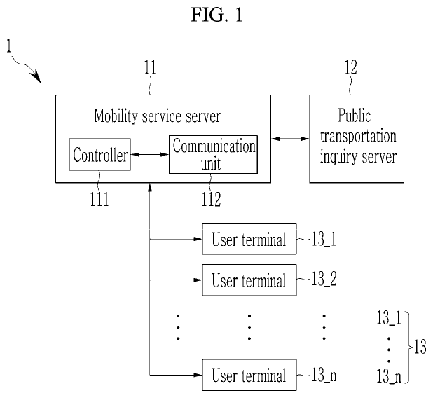

FIG. 1 is a block diagram schematically illustrating an example mobility service platform providing a transfer service using a mobility service and a public transportation service.

Hereinafter, the transfer service may include a service in which a user moves from a starting location (e.g., starting point) to a transfer point by using a public transportation and then moves from the transfer point to a destination by using a rideshare vehicle; a service in which a user moves from a starting location to a transfer point by a rideshare vehicle and then moves from the transfer point to a destination by a public transportation, and a service in which a user selects a transfer point within a service area where a mobility service is provided (hereinafter referred to as the mobility service available area) while riding a public transportation, and then moves from the transfer point to a destination by using a rideshare vehicle. Ridesharing (also referred to as ride-pooling) may include a service in which a user requests a ridesharing (or ride-pooling) vehicle and moves to an assigned vehicle according to the request. The ridesharing (or ride-pooling) vehicle assigned to one user may also be assigned to other user(s), so that the user may share all or part of the travel route using the ridesharing (or ride-pooling) vehicle with the other user(s).

The mobility service may refer to a user transportation service through which a rideshare vehicle provides transportation on a route based on calls (e.g., requests) by users who have subscribed to the corresponding service. The mobility service platform according may be implemented to provide a transfer service between a rideshare vehicle and public transportation (e.g., a bus, a train, etc.) when a user uses a public transportation service together with a mobility service.

The mobility service platform 1 may be a subject in which a mobility service server 11, a public transportation inquiry server 12, and a plurality of user terminals 13 perform the operations for providing a transfer service. The plurality of user terminals 13 may be a personal terminal of each of a plurality of users using the mobility service. The personal terminal 13 may be one of any types of portable terminals capable of transmitting and receiving information through a network (e.g., a wireless network). The personal terminal terminals 13 may include global positioning system (GPS) capability, and may be capable of acquiring location information through the GPS.

The mobility service server 11 may receive information about a starting location and a destination from a user terminal (hereinafter, target user terminal) 13_i which wants to use the transfer service among the plurality of user terminals 13, generate a recommended route, among a plurality of movement routes, that satisfies a recommendation condition for traveling by a combination of the mobility service and the public transportation service, and transmit the generated route to the target user terminal 13_i. The recommendation condition may include a condition in consideration of at least one of a trip charge (e.g., fare, fee, etc.) and a trip duration according to the combination of the mobility service and the public transportation service.

For example, as the recommendation condition, at least one of 1) a condition in which the distance traveled by using the mobility service becomes the maximum and 2) a condition in which the movement time is the shortest may be set in the mobility service server 11. The fee for the mobility service may be based on the number of times the service has been used, and the fee for the public transportation may be based on the distance traveled. Accordingly, the mobility service server 11 may generate a route in the same manner as in 1) in consideration of the fee, or may generate a route in the same manner as in 2) in consideration of the trip duration. The mobility service server 11 may determine the recommended route among the plurality of movement routes according to each of 1) and 2), and transmit the determined recommended route to the target user terminal 13_i.

The public transportation inquiry server 12 may obtain current location information of the public transportation, adjust information on the travel route of the public transportation, collect traveling information for the public transportation requested from the mobility service server 11, and transmit the collected traveling information to the mobility service server 11. The traveling information for the public transportation may include location information and the traveling route of the public transportation. The public transportation may refer to a transportation that may be used by a large number of users (e.g., a mass transit), such as a bus or a train, and incur a usage fee (e.g., a trip fare) according to a travel distance. The mobility service server 11 may determine a recommended route based on a starting location, a destination, and the traveling information for the public transportation.

An application for using the mobility service (herein, also referred to as a mobility service app) may be installed in each of the plurality of user terminals 13. A user may input a starting location and a destination through the mobility service app, and may select one of the plurality of recommended routes. Each of the plurality of user terminals 13 may process the information received from the mobility service server 11 through the mobility service app and display the processed information to the user, and process the information input through the mobility service app and transmit the processed information to the mobility service server 11. Hereinafter, the operation performed through the mobility service app installed in the terminal of each of the plurality of user terminals 13 will be described as an operation of the user terminal.

The mobility service server 11 may include a controller 111 and a communication unit 112.

The controller 111 may generate a recommended route based on a starting location and a destination, and reserve the mobility service based on the recommended route and traveling information for the public transportation. The controller 111 may provide a transfer service between the rideshare vehicle and the public transportation.

The communication unit 112 may receive information necessary to provide the transfer service under the control of the controller 111 from each of the plurality of user terminals 13, and transmit information indicating the recommended route generated by the controller 111 to each of the user terminals 13. The information necessary to provide the transfer service may include information indicating the destination of the route that the user wants to move and information indicating the location of the user. The communication unit 112 may request traveling information for the public transportation from the public transportation inquiry server 12, and receive the traveling information for the public transportation from the public transportation inquiry server 12.

The target user terminal 13_i receiving a push notification message indicating that the mobility service is available from the communication unit 112 may display the push notification message on the user interface through the mobility service app.

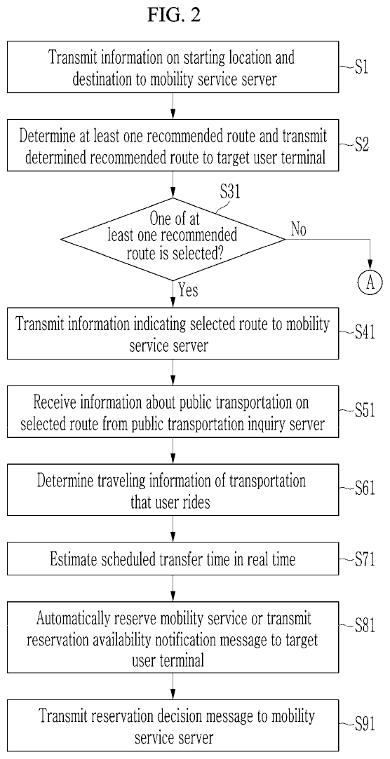

Hereinafter, the mobility service method will be described with reference to FIGS. 2 to 5.

First, among various methods of providing the transfer service, a case in which a user moves from a starting location to a transfer point by the public transportation and then moves from the transfer point to a destination by the rideshare vehicle will be described with reference to FIGS. 2 to 4.

FIG. 2 is a flowchart illustrating an example mobility service method.

The user may input a destination through the mobility service app installed in the target user terminal 13_i. The target user terminal 13_i may transmit information on a starting location that is a current user's location and the input destination according to the GPS information to the mobility service server 11 (S1). Alternatively, the user may input a location different from the current user's location as a starting location through the mobility service app installed in the target user terminal 13_i, and the target user terminal may also transmit the received information on the starting location and the destination to the mobility service server 11. Hereinafter, for convenience of description, it is assumed that the starting location is the current user's location.

The target user terminal 13_i may transmit a request for a transfer service in which the user moves from the starting location to the transfer point by the public transportation and then moves from the transfer point to the destination by the rideshare vehicle to the mobility service server 11.

The communication unit 112 may receive information on the starting location and the destination from the target user terminal 13_i. The controller 111 may generate a plurality of movement routes based on the starting location and the destination, determine at least one recommended route among the plurality of movement routes, and transmit the determined recommended route to the target user terminal 13_i through the communication unit 112 (S2).

The target user terminal 13_i may display the received at least one recommended route.

The user may select one of at least one recommended route through the mobility service app installed in the target user terminal 13_i (S31).

When the user selects one of at least one recommended route in operation S31, the target user terminal 13_i may transmit information indicating the selected route selected by the user to the mobility service server 11 (S41). The information indicating the selected route may include information indicating the type of public transportation (hereinafter, the public transportation on the selected route) serving as transportation from the starting location to the transfer point on the selected route.

The communication unit 112 may receive the information indicating the selected route from the target user terminal 13_i, and receive the information on the public transportation on the selected route from the public transportation inquiry server 12 (S51). The information on the public transportation on the selected route may include traveling information for the plurality of public transportations on the selected route and currently traveling. The communication unit 112 may receive the user's current location from the target user terminal 13_i. The controller 111 may compare the current location of the public transportation with the user's current location to check in real time that the user is moving according to the selected route.

The controller 111 may determine the traveling information of the transportation that the user has ridden based on the information on the public transportation on the selected route and the user's current location (S61).

The controller 111 may estimate in real time the time required to reach the transfer point on the selected route from a specific location on the selected route by the transportation that the user has ridden (hereinafter, a first scheduled transfer time) based on the traveling information about the transportation that the user has ridden (S71). The specific location on the selected route may be determined based on the current location and the traveling information of the transportation that the user has ridden.

When the first scheduled transfer time reaches a predetermined first reference value (e.g., the first scheduled transfer time is less than or equal to the predetermined first reference value away from the current time), the controller 111 may automatically (e.g., without requiring an explicit request from a user) reserve the mobility service from moving from the transfer point to the destination by the rideshare vehicle, or transmit a reservation availability push notification message to the target user terminal 13_i through the communication unit 112 (S81). Herein, the predetermined first reference value is a reference for the first scheduled transfer time in which the controller 111 may automatically reserve the mobility service or transmit the notification message. For example, when the first reference value is 30 minutes and the scheduled transfer time is within 30 minutes, the controller 111 may automatically reserve the mobility service or perform an operation of transmitting the notification message.

When the mobility service is automatically reserved, the controller 111 may cancel the reservation of the mobility service within an automatic reservation hold time or change the automatic reservation to a general reservation. The automatic reservation hold time may be a time during which the controller 111 is capable of determining whether to cancel the reservation or change the automatic reservation to a general reservation after automatically reserving the mobility service. The automatic reservation hold time may be predetermined as initial (e.g., default) information.

When the controller 111 may automatically make the reservation for the mobility service, the reservation state before it changes to the general reservation may also be indicated as a provisional reservation state, in which the reservation of the mobility service can be canceled within the automatic reservation hold time. The general reservation for the mobility service may indicate that the mobility service is predetermined to be used on a specific route at a specific time. Also, the provisional reservation for the mobility service may be a reservation made temporarily before the general reservation for the mobility service is made, and indicate a state that can be canceled or changed to the general reservation. Hereinafter, the change of the reservation state of the mobility service automatically reserved by the controller 111 from provisional reservation to general reservation is merely an example, and the present disclosure is not limited to the above exemplary embodiments. Accordingly, when the automatic reservation of the mobility service is not canceled, the user may use the mobility service according to a rideshare vehicle call due to the automatic reservation.

The controller 111 may make it impossible to cancel the reservation of the mobility service or may set a cancellation condition more strictly after the automatic reservation is changed to the general reservation. Herein, the strict setting of the cancellation condition may mean that it is more disadvantageous for the user to cancel the general reservation than for the user to cancel the provisional reservation, when considering the rideshare vehicle usage amount, vehicle call priority, and the like. The penalty due to the reservation cancellation (hereinafter, cancellation penalty) may include a decrease in priority in the rideshare vehicle call, an increase in the amount of use of the rideshare vehicle, a decrease in discount benefits, and the like when using the mobility service after reservation cancellation.

The reason that the controller 111 sets the automatic reservation hold time may be to efficiently determine the route of the rideshare vehicle. If the user can cancel the automatic reservation of the mobility service at any time after the automatic reservation hold time has elapsed, the rideshare vehicle may be rerouted to an unnecessary (e.g., more inefficient) route, so that this is to respond to the uncertainty.

Hereinafter, the operation of changing, by the controller 111, the reservation state of the mobility service from provisional reservation to general reservation may include an operation of making the general reservation for the mobility service. Hereinafter, the reservation of the mobility service by the controller 111 is assumed to make the automatic reservation or the general reservation for the mobility service.

Hereinafter, in order for the controller 111 to automatically reserve the mobility service, the distance from the current location of the public transportation on the selected route to the transfer point of the selected route, the distance from the user's current location to the transfer point, and the like will be considered together. Also, when the controller 111 reserves the mobility service, the controller 111 may call a rideshare vehicle.

The reservation availability push notification message may include information necessary to use the mobility service from the transfer point to the destination. For example, the reservation availability push notification message may include information indicating the location (e.g., the current location) of the rideshare vehicle and a time when the rideshare vehicle is expected to arrive at the transfer point.

When the target user terminal 13_i receives the reservation availability push notification message from the communication unit 112, the target user terminal 13_i may inquire the user whether to reserve the mobility service from the transfer point to the destination through the mobility service app, and transmit a reservation decision message input through the mobility service app to the mobility service server 11 (S91). The reservation decision message may include information indicating reservation approval or reservation rejection.

The controller 111 may reserve the mobility service (in case of reservation approval) or terminate the transfer service for the user (in case of reservation rejection) according to the information of the reservation decision message. Hereinafter, the operation of reserving, by the controller 111, the mobility service according to the reservation decision message of the reservation approval may include an operation of making, by the controller 111, the general reservation for the mobility service. When the mobility service is reserved, the controller 111 may determine a route of a rideshare vehicle (hereinafter, referred to as a first target rideshare vehicle) that will provide the reserved mobility service in consideration of the route of the reserved mobility service. For example, the controller 111 may determine the first target rideshare vehicle so that the user who has reserved the mobility service can ride the rideshare vehicle within 20 minutes at the transfer point. Therefore, the controller 111 may determine the route of the rideshare vehicle so that the first target rideshare vehicle passes through the transfer point within a predetermined time range based on the time (hereinafter, the transfer time) when the user is expected to arrive at the transfer point based on the first scheduled transfer time. Here, the predetermined time may be an error range for the transfer time. For example, when the transfer time is 40 minutes after the current time, the controller 111 may determine the route of the rideshare vehicle so that the first target rideshare vehicle arrives at the transfer point 40 minutes after the current time. In this case, the controller 111 may determine the first target rideshare vehicle in consideration of the route of the currently traveling rideshare vehicle and the transfer point of the user who has reserved the mobility service. For example, the controller 111 may regenerate a route in which the transfer point is added to the route of the currently traveling rideshare vehicle, and determine a rideshare vehicle corresponding to a route with the shortest total travel time according to the regenerated route as the first target rideshare vehicle. Hereinafter, the operation of making, by the controller 111, the reservation for the mobility service may include an operation of determining the first target rideshare vehicle and the route of the first target rideshare vehicle in consideration of the route of the reserved mobility service.

When the controller 111 automatically reserves the mobility service from the transfer point to the destination in operation S81, the communication unit 112 may determine whether to change the mobility service reservation state from provisional reservation to general reservation according to whether the reservation decision message is received within the automatic reservation hold time based on (e.g., relative to) the time when the mobility service is automatically reserved.

For example, when the communication unit 112 receives the reservation decision message including the information indicating the reservation approval within the automatic reservation hold time based on the time when the mobility service is automatically reserved, the controller 111 may change the reservation state of the automatically reserved mobility service from provisional reservation to general reservation. In addition, if the communication unit 112 does not receive the reservation decision message including the information indicating the reservation approval within the automatic reservation hold time based on (e.g., relative to) the time when the mobility service is automatically reserved, the controller 111 may cancel the automatically reserved mobility service.

When the reservation state of the mobility service is changed from provisional reservation to general reservation, the controller 111 may maintain the predetermined route of the first target rideshare vehicle as it is.

Also, when the provisional reservation of the automatically reserved mobility service is canceled, the controller 111 may cancel the call of (e.g., reservation with, request for, etc.) the rideshare vehicle. If the reservation of the mobility service is canceled, the controller 111 may determine the route of the rideshare vehicle again. For example, the controller 111 may regenerate a route that does not pass through the transfer point in the route of the first target rideshare vehicle. Hereinafter, the operation of canceling, by the controller 111, the reservation of the mobility service may include an operation of re-generating the first target rideshare vehicle and the route of the first target rideshare vehicle by reflecting the canceled route.

Alternatively, based on (e.g., relative to) the time when the mobility service is automatically reserved from the transfer point to the destination in operation S81, the controller 111 may determine whether to change the mobility service reservation to the general reservation according to whether the first scheduled transfer time reaches a predetermined second reference value within the automatic reservation hold time. In this case, the time indicated by the predetermined second reference value may be shorter than the time indicated by the predetermined first reference value. Here, the second predetermined reference value may be a reference for the first scheduled transfer time at which the controller 111 may change the reservation state of the automatically reserved mobility service from provisional reservation to general reservation. For example, if the automatic reservation hold time is 20 minutes and the second reference value is 10 minutes, when the first scheduled transfer time arrives within 10 minutes within 20 minutes based on the time when the controller 111 automatically makes the reservation for the mobility service, the controller 111 may change the reservation state of the mobility service from provisional reservation to general reservation.

For example, when the first scheduled transfer time reaches a predetermined second reference value (e.g., the first scheduled transfer time is less than or equal to the predetermined second reference value away from the current time) within the automatic reservation hold time based on the time when the mobility service is automatically reserved, the controller 111 may change the reservation state of the automatically reserved mobility service from provisional reservation to general reservation. For example, when the first scheduled transfer time does not reach the predetermined second reference value within the automatic reservation hold time based on the time when the mobility service is automatically reserved, the controller 111 may cancel the reservation of the automatically reserved mobility service.

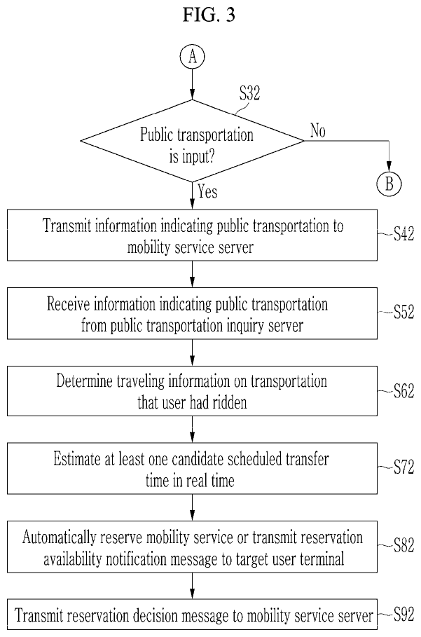

FIG. 3 is a flowchart illustrating an example mobility service method.

When the user does not select one of said at least one recommended route (e.g., within a threshold time limit) in operation S31, the user may input the public transportation currently used through the mobility service app installed in the target user terminal 13_i (S32).

When the user inputs the public transportation used in operation S32, the target user terminal 13_i may transmit information indicating the public transportation input by the user to the mobility service server 11 (S42).

In addition, the mobility service platform 1 may include a transportation card (e.g., fare payment card) server (not illustrated) for managing payment of a movement charge (e.g., trip fare) according to the use of transportation through a network according to an electronic payment request by using a transportation card based on stored transportation card information. When the user pays the movement charge through the transportation card in the public transportation used by the user, the transportation card server (not illustrated) may transmit the user's transportation card usage history to the mobility service server 11 in real time. In this case, based on the user's transportation card usage history received by the communication unit 112 from the transportation card server (not illustrated), the controller 111 may specify the public transportation used by the user. In the case where the controller 111 specifies the public transportation used by the user, the controller 111 may handle the case as the same as when the user inputs the public transportation used in operation S32.

Hereinafter, the public transportation input by the user is referred to as a target transportation.

The communication unit 112 may receive information indicating the target transportation from the target user terminal 13_i, and may receive information on the target transportation from the public transportation inquiry server 12 (S52). The information on the target transportation may include traveling information for the plurality of transportations (e.g., vehicles) belonging to the target transportation and currently traveling. For example, if the target transportation is a bus with a route number 110, traveling information may be for the plurality of buses belonging to the same bus route (e.g., No. 110).

The communication unit 112 may receive the user's current location from the target user terminal 13_i. The controller 111 may check the location of the public transportation that is the means by which the user moves to the transfer point in real time on the basis of the location of the target transportation and the user's current location received by the communication unit 112.

The controller 111 may determine the traveling information of the transportation that the user has ridden from the information on the target transportation and the user's current location (S62).

The controller 111 may determine at least one point (e.g., location) where the user can ride the rideshare vehicle as a candidate transfer point based on the traveling information of the transportation that the user has ridden and the mobility service available area. The controller 111 may estimate at least one time (hereinafter, referred to as candidate scheduled transfer time) required to reach each of said at least one candidate transfer point from a specific location on the traveling route of the transportation that the user has ridden by the transportation the user has ridden in real time (S72). The specific location on the traveling route of the transportation that the user has ridden may be determined based on the current location and the traveling information of the transportation in which the user has ridden.

For example, the controller 111 may derive at least one candidate transfer point that satisfies the transfer condition among contact points of the movement route of the target transportation and the mobility service available area. The transfer condition may include a condition in consideration of at least one of a movement charge, movement time, walking time, and transfer waiting time according to a combination of the mobility service and the public transportation service.

If one of said at least one candidate scheduled transfer time reaches a predetermined first reference value, the controller 111 may determine the corresponding candidate transfer point as a transfer point. The controller 111 may automatically reserve the mobility service for the user to move from the transfer point to the destination by the rideshare vehicle, or transmit the reservation availability push notification message to the target user terminal 13_i through the communication unit 112 (S82).

The reservation availability push notification message may include information necessary to use the mobility service from the transfer point to the destination. For example, the reservation availability push notification message may include information indicating the location of the rideshare vehicle and a time when the rideshare vehicle is expected to arrive at the transfer point.

After the target user terminal 13_i receives the reservation availability push notification message from the communication unit 112, the target user terminal 13_i may inquire whether to reserve the mobility service from the transfer point to the destination to the user through the app, and transmit the reservation decision message input through the app to the mobility service server 11 (S92). The reservation decision message may include information indicating reservation approval for the transfer point or reservation rejection for all of at least one candidate transfer point.

The controller 111 may reserve the mobility service (e.g., in case of reservation approval) or terminate the transfer service for the user (e.g., in case of reservation rejection) according to the information of the reservation decision message.

After the controller 111 automatically reserves the mobility service from the transfer point to the destination in operation S82, the controller 111 may determine whether to change the reservation state of the mobility service from provisional reservation to general reservation according to whether the communication unit 112 receives the reservation decision message within the automatic reservation hold time based on the time when the mobility service is automatically reserved.

Alternatively, the controller 111 may determine whether to change the mobility service reservation state from provisional reservation to general reservation according to whether the first scheduled transfer time reaches the predetermined second reference value within the automatic reservation hold time based on the time when the mobility service is automatically reserved from the transfer point to the destination in operation S82.

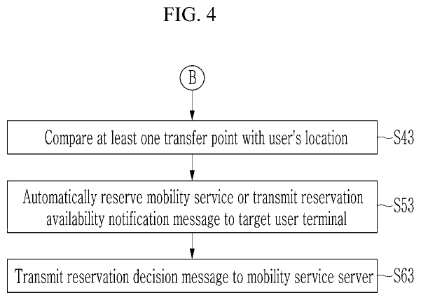

FIG. 4 is a flowchart illustrating an example mobility service method.

If the user does not input (e.g., within a threshold time limit) the information of the public transportation method used by the user in operation S32 to the target user terminal 13_i, the communication unit 112 may receive the current location of the target user terminal 13_i, and the controller 111 may compare the user's location with at least one transfer point on at least one recommended route (S43).

If the user's location is within a predetermined regional range based on any one of said at least one transfer point, the controller 111 may automatically reserve the mobility service by which the user moves from the transfer point adjacent to the user's location to the destination by the rideshare vehicle, or transmit the reservation availability push notification message to the target user terminal 13_i through the communication unit 112 (S53).

The reservation availability push notification message may include information necessary to use the mobility service from the adjacent (e.g., located within a threshold distance) transfer point to the destination. For example, the reservation availability push notification message may include information indicating the location of the rideshare vehicle and a time when the rideshare vehicle is expected to arrive at the transfer point.

If the target user terminal 13_i receives the reservation availability push notification message from the communication unit 112, the target user terminal 13_i may inquire whether to reserve the mobility service from the adjacent transfer point to the destination to the user through the app, and transmit the reservation decision message input through the app to the mobility service server 11 (S63). The reservation decision message may include information indicating reservation approval or reservation rejection.

The controller 111 may reserve the mobility service (e.g., in case of reservation approval) or terminate the transfer service for the user (e.g., in case of reservation rejection) according to the information of the reservation decision message.

If the controller 111 automatically reserves the mobility service from the transfer point to the destination in operation S53, the communication unit 112 may determine whether to change the mobility service reservation state from provisional reservation to general reservation according to whether the reservation decision message is received within the automatic reservation hold time based on the time when the mobility service is automatically reserved.

Alternatively, the controller 111 may determine whether to change the mobility service reservation state from provisional reservation to general reservation according to whether the time taken to reach the transfer point from the user's current location to a predetermined reference value within the automatic reservation hold time based on (e.g., relative to) the time when the mobility service from the transfer point to the destination is automatically reserved in operation S53. Here, the predetermined reference value may be a reference for the time taken to reach the transfer point from the user's current location, in which the controller 111 is capable of changing the reservation state of the automatically reserved mobility service from provisional reservation to general reservation. For example, in the case where the automatic reservation hold time is 20 minutes and the predetermined reference value is 10 minutes, if the time taken to reach the transfer point from the user's current location within minutes based on the time when the controller 111 automatically reserves the mobility service arrives within 10 minutes, the controller 111 may change the reservation state of the mobility service from provisional reservation to general reservation.

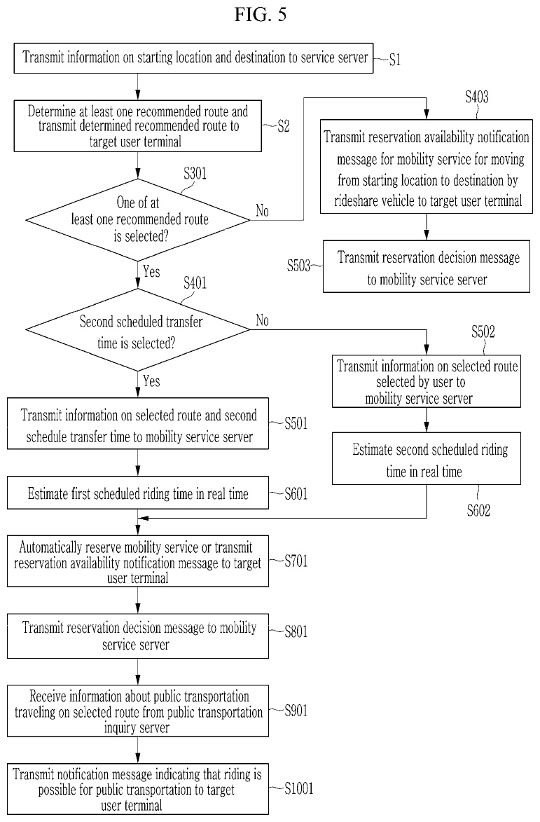

Next, among various methods of providing the transfer service, a case in which the user arrives at a destination by transferring to the public transportation after moving from a starting location to a transfer point by a rideshare vehicle will be described with reference to FIG. 5. Hereinafter, in the description of the controller 111, a description of portions overlapping with the previous description may be omitted.

FIG. 5 is a flowchart illustrating an example mobility service method.

The user may input a destination through the mobility service app installed in the target user terminal 13_i. The target user terminal 13_i may transmit information on a starting location that is a current user's location and the input destination according to the GPS information to the mobility service server 11 (S1). The target user terminal 13_i may transmit, to the mobility service server 11, a request for a transfer service in which the user moves from the starting location to the transfer point by the rideshare vehicle, and then transfers to the public transportation to arrive at the destination.

The communication unit 112 may receive information on the starting location and the destination from the target user terminal 13_i. The controller 111 may generate a plurality of movement routes based on the starting location and the destination, determine at least one recommended route among the plurality of movement routes, and transmit the determined recommended route to the target user terminal 13_i through the communication unit 112 (S2).

The target user terminal 13_i may display the received at least one recommended route.

The user may select one of at least one recommended route through the mobility service app installed in the target user terminal 13_i (S301). Alternatively, if the user's movement route based on the user's location matches one of the use's recommended routes, the controller 111 may treat the one matching route as the one selected by the user. When the user's movement route based on the user's location falls within a range of a predetermined distance based on an arbitrary route on one route of the user's recommended routes, the controller 111 may determine that the user's movement route matches the one route.

If the user selects one of said at least one recommended route in operation S301, the user may select a time (hereinafter, a second scheduled transfer time) to ride the public transportation at the transfer point on the selected route selected by the user (S401).

If the user selects the second scheduled transfer time in operation S401, the target user terminal 13_i may transmit information on the selected route selected by the user and the second scheduled transfer time to the mobility service server 11 (S501).

Following operation S501, the communication unit 112 may receive the information on the selected route and the second scheduled transfer time, and the controller 111 may estimate a time (hereinafter, referred to as a first scheduled ride time) when the user is expected to ride the rideshare vehicle based on the selected route and the second scheduled transfer time in real time (S601). For example, the controller 111 may estimate the first scheduled riding time based on the second scheduled transfer time and the time required to move from the starting location to the transfer point by the rideshare vehicle.

If the user does not select the second scheduled transfer time in operation S401, the target user terminal 13_i may transmit the information on the selected route selected by the user to the mobility service server 11 (S502).

Following operation S502, the communication unit 112 may receive information on the selected route, and the controller 111 may estimate a time (hereinafter referred to as a second scheduled riding time) when the user is expected to ride the rideshare vehicle based on the user's current location and the selected route in real time (S602). For example, the mobility service server 11 may estimate the second scheduled riding time based on the user's current location and the current location of the rideshare vehicle that the user is expected to ride on the selected route.

Following operation S601 or S602, when the time from the current time to the scheduled riding time reaches a predetermined third reference value (e.g., the estimated time of arrival at the transfer point is within the predetermined third reference value) or the current user's location falls within the predetermined regional range, the controller 111 may automatically reserve a mobility service for moving from the starting location to the transfer point by the rideshare vehicle, or transmit a reservation availability push notification message to the target user terminal 13_i through the communication unit 112 (S701).

The scheduled riding time may be the first scheduled riding time or the second scheduled riding time. Here, the predetermined third reference value may be a reference for the time from the current time at which the controller 111 may automatically reserve the mobility service or transmit the notification message to the scheduled riding time. For example, when the third reference value is 30 minutes, and when the time from the current time to the scheduled riding time is within 30 minutes, the controller 111 may automatically reserve the mobility service or perform the notification message transmission operation.

If the mobility service is automatically reserved, the controller 111 may cancel the reservation of the mobility service or change the automatic reservation to the general reservation within the automatic reservation hold time. The automatic reservation hold time is a time during which the controller 111 is capable of determining whether to cancel the reservation or change the automatic reservation to the general reservation after the controller 111 automatically reserves the mobility service. The automatic reservation hold time may be predetermined as initial information.

If the controller 111 reserves the mobility service, the controller 111 may call (e.g., send a request for) the rideshare vehicle. If the controller 111 reserves the mobility service, the time from when the controller 111 calls the vehicle to when the vehicle arrives at the point where the user will ride the vehicle may be determined. Hereinafter, the time from when the controller 111 calls the vehicle to the vehicle arrives at the point where the user will ride the vehicle is referred to as dispatch time.

For example, if the mobility service is provisionally reserved, the controller 111 may determine the route of the rideshare vehicles as a primary route in consideration of the dispatch time in the case of provisional reservation. In addition, the controller 111 may determine the route of the rideshare vehicles as a secondary route in consideration of the dispatch time in the case of the general reservation. If the reservation state is provisional reservation, the controller 111 may add a stopover point according to the reservation of the mobility service of another user terminal after the provisional reservation. When the reservation state is changed from provisional reservation to general reservation, the controller 111 does not add any more stopover point(s) according to the mobility service reservation of other user terminals after the change to the general reservation, and the controller 111 may determine the route at the time of the change of provisional reservation to general reservation is the secondary route.

The dispatch time in the case where the controller 111 makes the provisional reservation for the mobility service may be longer than the dispatch time in the case of the general reservation.

For example, in the case where the dispatch time in the case where the controller 111 makes to provisional reservation for the mobility service is 20 minutes, and the dispatch time in the case where when the controller 111 makes the general reservation for the mobility service is 10 minutes, if the controller 111 makes the provisional reservation for the mobility service, the controller 111 may determine the routes of the rideshare vehicles that allow the rideshare vehicle to arrive at the point where the user will ride within 20 minutes as the primary route, and if the reservation state is changed from provisional reservation to general reservation, the controller 111 may determine the routes of the rideshare vehicles that allow the rideshare vehicle to arrive at the point where the user will ride within 10 minutes as the secondary route.

The operation of the controller 111 for the dispatch time may be similarly applied even to the foregoing case where the user moves from the starting location to the transfer point by the public transportation and then moves from the transfer point to the destination by the rideshare vehicle.

The reservation availability push notification message may include information relevant to use the mobility service from the current point to the transfer point. For example, the reservation availability push notification message may include information indicating the location of the rideshare vehicle and the dispatch time.

After the target user terminal 13_i receives the reservation availability push notification message from the communication unit 112, the target user terminal 13_i may inquire whether to reserve the mobility service from the transfer point to the destination to the user through the mobility service app, and transmit the input reservation decision message to the mobility service server 11 through the mobility service app (S801). The reservation decision message may include information indicating reservation approval or reservation rejection.

The controller 111 may reserve the mobility service (e.g., in case of reservation approval) or terminate the transfer service for the user (e.g., in case of reservation rejection) according to the information of the reservation decision message.

When the controller 111 automatically reserves the mobility service from the starting location to the transfer point in operation S701, the controller 111 may determine whether to change the mobility service reservation state from provisional reservation to general reservation according to whether the communication unit 112 receives the reservation decision message within the automatic reservation hold time based on the time when the mobility service is automatically reserved.

Alternatively, the controller 111 may determine whether to change the mobility service reservation state from provisional reservation to general reservation according to whether the time from the current time to the scheduled riding time reaches (e.g., is less than or equal to) a predetermined fourth reference value within the automatic reservation hold time based on (e.g., relative to) the time at which the controller 111 makes the automatic reservation for the mobility service from the starting location to the transfer point in operation S701. In this case, the time indicated by the predetermined fourth reference value may be shorter than the time indicated by the predetermined third reference value. Here, the predetermined fourth reference value may be a reference for the time from the current point in time at which the controller 111 can change the reservation status of the automatically reserved mobility service from provisional reservation to general reservation time to the scheduled riding time. For example, in the case where the automatic reservation hold time may be 20 minutes and the fourth reference value may be 10 minutes, if the time from the current time to the scheduled riding time within 20 minutes relative to the time when the controller 111 automatically reserved the mobility service arrives reaches within 10 minutes, the controller 111 may change the reservation state of the mobility service from provisional reservation to general reservation.

The communication unit 112 may receive the user's current location from the target user terminal 13_i, and may receive information on the public transportation for moving the selected route from the public transportation inquiry server 12 (S901). The information on the public transportation moving the selected route may include a plurality of traveling information for the plurality of transportation belonging to the public transportation moving the selected route and currently traveling.

The communication unit 112 may transmit a riding availability push notification message for public transportation to the target user terminal 13_i (S1001). The riding availability push notification message may include information necessary to use public transportation from the transfer point to the destination. For example, the riding availability push notification message may include information indicating a detailed location of a public transportation stop at the transfer point, a route map of the public transportation available at the stop, and a scheduled arrival time.

If the user does not select one of said at least one recommended route in operation S301, the controller 111 may transmits the reservation availability push notification message for the mobility service by which the user moves from the starting location to the destination by the rideshare vehicle to the target user terminal 13_1 through the communication unit 112 (S403).

If the target user terminal 13_i receives the reservation availability push notification message from the communication unit 112, the target user terminal 13_i may inquire whether to reserve the mobility service from the starting location to the destination to the user through the mobility service app, and transmit the reservation decision message input through the mobility service app to the mobility service server 11 (S503). The reservation decision message may include information indicating reservation approval or reservation rejection.

The controller 111 may reserve the mobility service (in case of reservation approval) or terminate the transfer service for the user (in case of reservation rejection) according to the information of the reservation decision message.

While this disclosure has been described in connection with what is presently considered to be practical exemplary embodiments, it is to be understood that the disclosure is not limited to the disclosed embodiments.

What is claimed is:

1. A mobility service platform comprising:
a public transportation inquiry server for collecting traveling information for a public transportation; and
a mobility service server for providing a mobility service for transporting a user via a rideshare vehicle traveling on a route based on a request from the user, and for providing a transfer service between the rideshare vehicle and the public transportation,
wherein the mobility service server is configured to:
receive a starting location and a destination from a user terminal for providing the mobility service;
receive the traveling information from the public transportation inquiry server;
generate, based on the starting location, the destination, and the traveling information, at least one recommended route among a plurality of routes that are traveled by a combination of the rideshare vehicle and the public transportation; and
reserve the mobility service based on the at least one recommended route.

2. The mobility service platform of claim 1, wherein the transfer service enables the user to move from the starting location to a transfer point via the public transportation, and move from the transfer point to the destination via the rideshare vehicle.

3. The mobility service platform of claim 2, wherein the mobility service server is further configured to:
based on a scheduled transfer time required to move from a predetermined location to the transfer point via the public transportation exceeding a first reference value, make a reservation for the mobility service for moving from the transfer point to the destination via the rideshare vehicle.

4. The mobility service platform of claim 3, wherein the mobility service server is further configured to:
cancel the reservation based on not receiving, within a predetermined time duration after making the reservation, a reservation decision message indicating reservation approval from the user terminal.

5. The mobility service platform of claim 3, wherein the mobility service server is further configured to:
cancel the reservation based on a scheduled transfer time not satisfying a second reference value within a predetermined time duration after making the reservation.

6. The mobility service platform of claim 3, wherein the mobility service server is further configured to:
receive, from the public transportation inquiry server and based on receiving from the user terminal a user selection input for the at least one recommended route, traveling information about a first public transportation on the selected route.

7. The mobility service platform of claim 3, wherein the mobility service server is further configured to:
receive, from the user terminal and based on a user selection input for the at least one recommended route not being received from the user terminal, information indicating:
a location of the user, and
a first public transportation;
receive, from the public transportation inquiry server, traveling information for a plurality of public transportations; and
determine, based on the traveling information and the location of the user, traveling information of the public transportation that the user rode among the plurality of public transportations.

8. The mobility service platform of claim 2, wherein the mobility service server is further configured to:
based on a scheduled transfer time required to move from a predetermined location to the transfer point via the public transportation satisfying a reference value, transmit, to the user terminal, a push notification message indicating that a reservation for the mobility service from the transfer point to the destination is available.

9. The mobility service platform of claim 8, wherein the mobility service server is further configured to:
based on receiving a message indicating a reservation approval for the push notification, make the reservation.

10. The mobility service platform of claim 1, wherein the transfer service enables the user to move from the starting location to a transfer point via the rideshare vehicle, and move from the transfer point to the destination via the public transportation.

11. The mobility service platform of claim 10, wherein the mobility service server is further configured to:
receive, from the user terminal, information about:
a selected route from among the at least one recommended route, and
a scheduled transfer time, wherein the scheduled transfer time indicates when the user is expected to ride the public transportation at the transfer point on the selected route.

12. The mobility service platform of claim 11, wherein the mobility service server is further configured to estimate, based on the scheduled transfer time and a time required to move from the starting location to the transfer point via the rideshare vehicle, a time at which the user is expected to ride the rideshare vehicle.

13. The mobility service platform of claim 1, wherein the mobility service server is further configured to determine, among a plurality of routes that are traveled by the combination of the rideshare vehicle and the public transportation from the starting location to the destination, a recommended route that satisfies a predetermined condition, wherein the predetermined condition includes at least one of:
maximizing a distance traveled by the rideshare vehicle, or
minimizing a time required to travel from the starting location to the destination.

14. A method comprising:
receiving, by a mobility service server and from a user terminal:
information on a starting location and a destination, and
a request for a transfer service in which a user moves from the starting location to a transfer point via a public transportation, and moves from the transfer point to the destination via a rideshare vehicle;
determining, by the mobility service server, at least one recommended route that is traveled by a combination of the rideshare vehicle and the public transportation based on the starting location, the destination, and traveling information for the public transportation;
transmitting the determined at least one recommended route to the user terminal;
based on a selection input for one of the at least one recommended route being received from the user terminal, receiving, by the mobility service server and from a public transportation inquiry server, traveling information for a plurality of public transportations on the selected route; and
estimating, by the mobility service server, a scheduled transfer time required to move from a predetermined location to the transfer point via the public transportation.

15. The method of claim 14, further comprising:
reserving, by the mobility service server, a mobility service for moving from the transfer point to the destination via the rideshare vehicle based on the scheduled transfer time satisfying a first reference value.

16. The method of claim 14, further comprising:
transmitting, by the mobility service server, to the user terminal, and based on the scheduled transfer time satisfying a first reference value, a push notification message indicating that a reservation for a mobility service for moving from the transfer point to the destination via the rideshare vehicle is available.

17. The method of claim 14, further comprising:
based on a second selection input for one of the at least one recommended route being not received from the user terminal, receiving, by the mobility service server and from the user terminal, information indicating:
a location of the user, and
a second public transportation;
receiving, by the mobility service server and from the public transportation inquiry server, traveling information for a plurality of second public transportations;
determining, by the mobility service server, based on the traveling information for the plurality of second public transportations, and further based on an area in which a mobility service is available, at least one candidate transfer point for transferring to the rideshare vehicle; and
estimating, by the mobility service server, at least one time required to move from a predetermined location to each of the at least one candidate transfer point via the second public transportation.

18. The method of claim 17, further comprising:
reserving, by the mobility service server, a mobility service for moving to the destination via the rideshare vehicle from a candidate transfer location, of the at least one candidate transfer location, corresponding to the estimated at least one time satisfying a reference value.

19. The method of claim 17, further comprising:
transmitting, by the mobility service server, a push notification message indicating that a reservation is available for the mobility service for moving via the rideshare vehicle from a location, at which the estimated at least one time satisfies a reference value among the determined at least one candidate transfer point, to the destination.

20. The method of claim 14, wherein the determining of the at least one recommended route comprises:
generating, based on the starting location, the destination, and the traveling information for the public transportation, a plurality of routes that are traveled by the combination of the rideshare vehicle and the public transportation; and
determining, among the plurality of routes, the at least one recommended route that satisfies a predetermined condition including at least one of:
a distance traveled by the rideshare vehicle, or
a time required to move from the starting location to the destination.

21. A method comprising:
receiving, by a mobility service server and from a user terminal:
information on a starting location and a destination, and
a request for a transfer service in which a user moves from the starting location to a transfer point via a rideshare vehicle, and moves from the transfer point to the destination via a public transportation;
determining, by the mobility service server, at least one recommended route that is traveled by a combination of the rideshare vehicle and the public transportation based on the starting location, the destination, and traveling information for the public transportation;
transmitting the determined at least one recommended route to the user terminal;
based on a selection input for one of the at least one recommended route being received from the user terminal, receiving, by the mobility service server and from the user terminal, an input of a scheduled transfer time at which the user is expected to ride the public transportation at the transfer point on a selected route among the at least one recommended route;
estimating, by the mobility service server, based on the scheduled transfer time, and further based on a time required to move from the starting location to the transfer point via the rideshare vehicle, a first time at which the user is expected to ride the rideshare vehicle; and
based on the first time satisfying a reference value, performing one of:
reserving, by the mobility service server, a mobility service for moving from the starting location to the transfer point via the rideshare vehicle, or
transmitting, to the user terminal, a push notification message indicating that a reservation for the mobility service is available.

22. The method of claim 21, further comprising:
based on the selection input for the one of the at least one recommended route being received from the user terminal and further based on a second selection input not being received from the user terminal for the scheduled transfer time at which the user is expected to ride the public transportation at the transfer point among the at least one recommended route, estimating, by the mobility service server and based on a current location of the user and the selected route, a second time at which the user is expected to ride the rideshare vehicle; and
based on a time period relative to the second time satisfying a second reference value, performing one of:
reserving, by the mobility service server, the mobility service for moving from the starting location to the transfer point via the rideshare vehicle, or
transmitting the push notification message indicating that the reservation for the mobility service is available.

23. The method of claim 21, further comprising:
receiving, by the mobility service server and from the user terminal, a current location of the user;
receiving, by the mobility service server and from a public transportation inquiry server, information on the public transportation on the selected route; and transmitting, by the mobility service server, to the user terminal, and based on the information on the public transportation, a push notification message for the public transportation.

24. The method of claim 23, wherein the information on the public transportation includes traveling information for a plurality of transportations.

25. The method of claim 21, further comprising:
based on a second selection input for the one of the at least one recommended route being not received from the user terminal, transmitting, by the mobility service server and to the user terminal, the push notification message indicating that the reservation for the mobility service for moving from the starting location to the destination via the rideshare vehicle is available.
